(19) United States
(12) Patent Application Publication
(10) Pub. No.: US 2018/0202186 A1
(43) Pub. Date: Jul. 19, 2018

(54) TENT WIND ROPE ADJUSTING STRUCTURE

(71) Applicant: Shih-Hui Chang, New Taipei City (TW)

(72) Inventor: Shih-Hui Chang, New Taipei City (TW)

(21) Appl. No.: 15/792,549

(22) Filed: Oct. 24, 2017

(30) Foreign Application Priority Data
Jan. 16, 2017 (TW) 106200744

(51) Int. Cl. E04H 15/32

(52) U.S. Cl. CPC E04H 15/322; F16G 11/14

(57) ABSTRACT

A tent wind rope adjusting structure includes: an adjusting plate, having a plate body, with a front section and a rear section of the plate body provided each with a through hole, a side of the adjusting plate is provided with at least a hook, the hook is formed by cutting a notch at a side of the plate body, and having a hook opening and an indent portion; a wind rope, passing through the two through holes of the adjusting plate, with a tail end of the wind rope provided with a rope loop; and an elastic clip buckle, having a press-able rope clipping hole for the wind rope to pass through, to allow the elastic clip buckle to move between a rear section of the wind rope and the adjusting plate.

### BACKGROUND OF THE INVENTION

### Field of the Invention

The present invention relates to a wind rope adjusting structure, and in particular to a tent wind rope adjusting structure, in which a side of the adjusting plate is provided with a hook, for a rope loop at the tail end of the wind rope to hook on, so that the rear section of the wind rope can be adjusted readily to a proper length, to expedite wind rope tie-up, while putting up a tent stably.

### The Prior Arts

Along with the progress and prosperity of the economic development, outdoor recreation activities are getting popular. For which, camping is an excellent activity for the city dwellers to get close to the Nature. In camping, a tent is essential in providing a place for rest and recreation. For a tent to be suitable for use, it must be light weight, easy to carry, and can be put up or pulled down readily.

In general, the ways of setting up a tent are as follows: firstly, putting a plurality of tubes into the sleeves disposed on the tent cloth, or connecting a plurality of single-section tubes into a long rod, to prop up the tent cloth. Then, using the wind rope to stretch and pull tight the long rod and the tent cloth, and using the ground nail to fix the tent cloth onto the ground. However, for the conventional wind rope, the adjusting structure is not efficient, so that after the ground nails of the tent are fixed onto the ground, the other wind ropes have to be adjusted separately one-by-one to a proper length, to achieve a stable tent. As such, the adjusting process is complicated, inefficient, and time consuming; and even worse, some of the wind ropes are liable to get loose, to cause falling down of the tent.

In particular, for the conventional regulating plate, altogether three holes are placed at its two ends. The upper and lower holes are for the wind rope to pass through, then the wind rope is bent to pass the remaining hole. Subsequently, the tail end is tied into a knot or a metal piece is provided, to form into a fixed formation through blocking with the regulating plate. Since the hole is of a closed type and there is no notch on its side, so that when there are trees or railings in the camping ground getting in the way, the tail end of the wind rope and the regulating plate can not be untied or detached readily to get around. Therefore, it has to find another position on the ground to put the ground nail in, to tie and fix the wind rope. As such, the overall design is not practicable.

Further, in the Prior Art, the wind rope does not have a proper storage design. Therefore, in recovering and collecting the wind ropes after pulling down the tent, the wind ropes tend to tie into knots or intertwine with each other, to cause quite inconvenience for the next time usage.

Therefore, presently, the design and performance of the tent wind rope adjusting structure is not quite satisfactory, and it leaves much room for improvement.

### SUMMARY OF THE INVENTION

In view of the problems and drawbacks of the prior art, the present invention provides a tent wind rope adjusting structure, to effectively overcome the shortcomings of the prior art.

A major objective of the present invention is to provide a tent wind rope adjusting structure, that includes: an adjusting plate, a wind rope, and an elastic clip buckle. Wherein, the adjusting plate is provided with a plate body, with a front section and a rear section of the plate body provided each with a through hole, a side of the adjusting plate is provided with at least a hook, the hook is formed by cutting a notch on a side of the plate body, and having a hook opening and an indent portion. The wind rope is adapted to pass through the two through holes of the adjusting plate, with a tail end of the wind rope provided with a rope loop. And the elastic clip buckle is provided with a press-able rope clipping hole for the wind rope to pass through, so that the elastic clip buckle can be placed between a rear section of the wind rope and the adjusting plate.

Therefore, by using the hook on the side of the adjusting plate, for the rope loop at the tail end of the wind rope to hook on, the rear section of the wind rope can be adjustable freely to a length required, to expedite the wind rope tying up, and save the tent set up time, while achieving stable support for the tent.

In application, the shape of the adjusting plate can be selected from one of a group consisting of: a long rectangle, an ellipse, an arc-dart, a quadrilateral, a triangle, a polygon, and a bone.

Further, on both sides of a middle section of the adjusting plate are each formed an indent-arc-shape hand held portion, for a hand to hold the adjusting plate to perform adjusting length of the wind rope, but the present invention is not limited to this.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a tent wind rope adjusting structure used in putting up a tent according to an embodiment of the present invention;

FIG. 2 is a schematic diagram of a tent wind rope adjusting structure according to an embodiment of the present invention;

FIG. 3 is an enlarged view of a tent wind rope adjusting structure showing the wind rope being pulled tight and hooked onto the adjusting plate according to an embodiment of the present invention; and

FIG. 4 is a schematic diagram of tent wind rope adjusting structure furling up for storage according to an embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

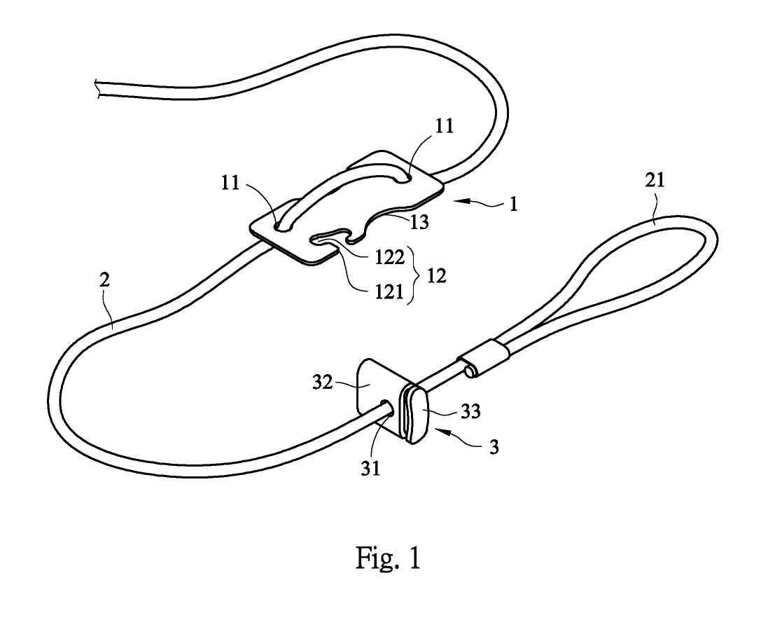

Refer to FIG. 1 for a schematic diagram of a tent wind rope adjusting structure according to an embodiment of the present invention. As shown in FIG. 1, the present invention provides a tent wind rope adjusting structure, comprising: an adjusting plate 1, a wind rope 2, and an elastic clip buckle 3.

The adjusting plate 1 is provided with a plate body, with the front section and the rear section of the plate body provided each with a through hole 11, a side of the adjusting plate 1 is provided with at least a hook 12, the hook 12 is formed by cutting a notch on a side of the plate body, and having a hook opening 121 and an indent portion 122. The indent portion 122 is preferably of a r-arc shape, but the present invention is not limited to this.

The wind rope 2 is adapted to pass through the two through holes 11 of the adjusting plate 1, with a tail end of the wind rope 2 provided with a rope loop 21.

The elastic clip buckle 3 is provided with a press-able rope clipping hole 31 for the wind rope 2 to pass through, so that the elastic clip buckle 3 can be placed between a rear section of the wind rope 2 and the adjusting plate 1. In application, the elastic clip buckle 3 is formed by an upper hole cover piece 32, a lower hole cover piece 33, and a spring (not shown) disposed therein.

In application, the regulating plate 1 can be a flat plate body or a crooked plate body (not shown). The adjusting plate 1 is of a shape selected from one of a group consisting of: a long rectangle, an ellipse, an arc-dart, a quadrilateral, a triangle, a polygon, and a bone, but the present invention is not limited to this.

In an embodiment of the present invention, on both sides of a middle section of the adjusting plate 1 are each formed an indent-arc-shape hand held portion 13, for a hand to hold the adjusting plate 1 to adjust length of the wind rope 2, but the present invention is not limited to this.

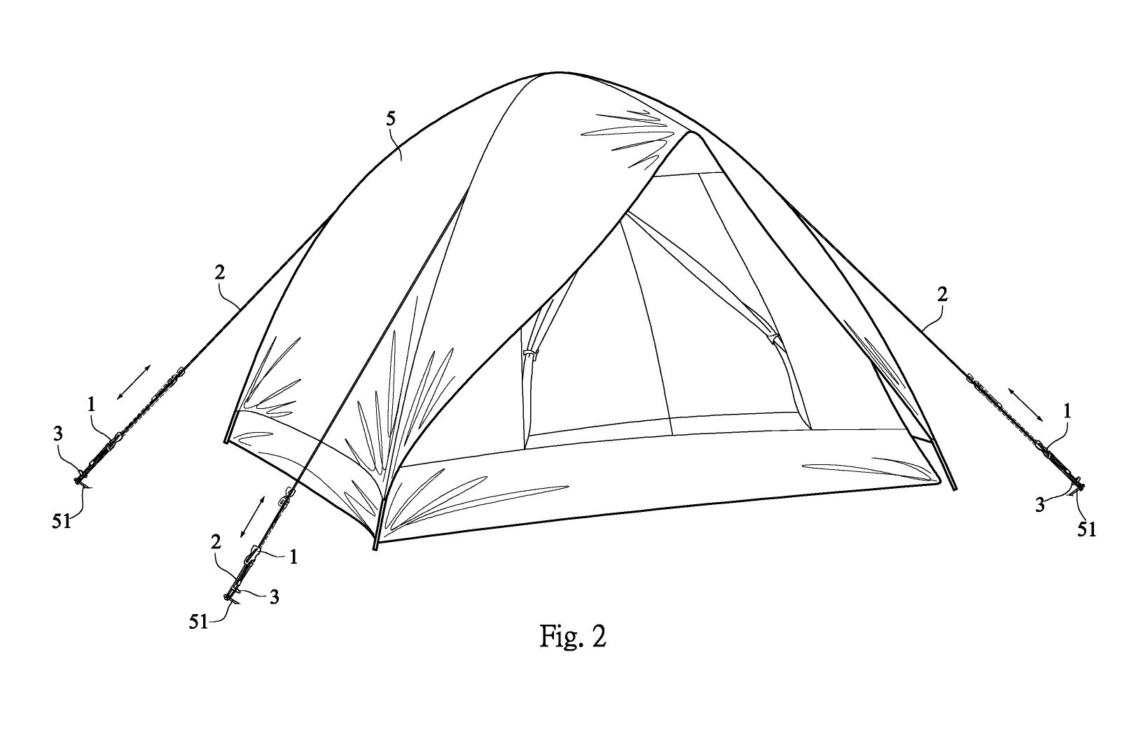

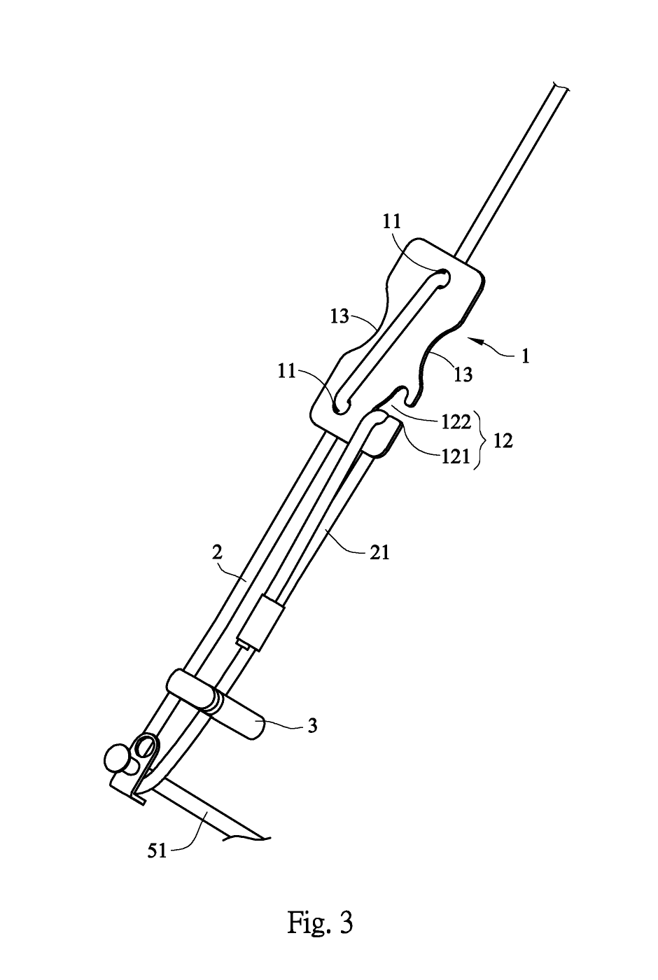

In an embodiment of the present invention, as shown in FIGS. 1 to 3, in putting up a tent 5, after placing the surrounding ground nails 51 onto the ground for positioning, winding each of the wind ropes 2 on the sides of the tent 5 around the corresponding ground nail 51, to pull tight the wind rope 2. Then, hooking the rope loop 21 at the tail end of the wind rope 2 onto the hook 2 on a side of the adjusting plate 1. Subsequently, pushing the adjusting plate 1 to pull tight the wind rope 2, to adjust freely the rear section of the wind rope 2 to a proper length, so that the wind rope 2 is pulled tight, to fix the tent 5 more stably.

The advantage of the overall design of the tent wind rope adjusting structure of the present invention is that, in putting up a tent 5, the wind rope 2 tying process can be made easy and simple, while the wind rope 2 tying speed can be expediated, to achieve good fixing effect. As such, this could save time in putting up a tent 5, and realize stable support for the tent 5.

Further, the hook 12 on a side of the regulating plate 1 is of an open type, for the rope loop 21 at the tail end of the wind rope 2 to be hooked movably thereon. When there are trees or railings in the camping ground getting in the way of tent put-up, the rope loop 21 and the hook 12 can be detached easily to get around the trees and the railings, and then be put together again. Therefore, the wind rope 2 can be tied to the ground nail 51 fixedly and stably without the need to find another place for putting the ground nail 51, so its mobility and practicality are far better than that of the Prior Art. Besides, another advantage of the present invention is that, the same design of wind rope 2 tying can be applied to tying the clothesline to the laundry line bracket when hanging the laundry to dry, while living at home or camping.

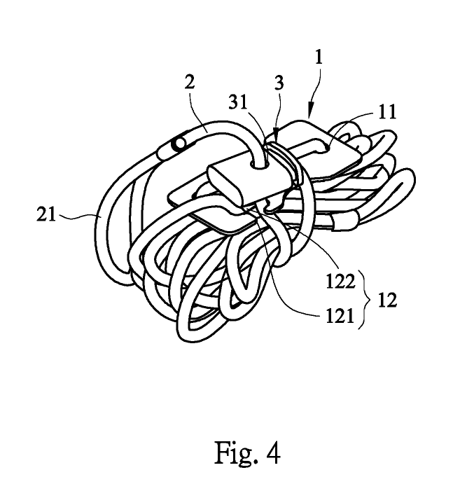

Finally, refer to FIG. 4 for a schematic diagram of tent wind rope adjusting structure furling up for storage according to an embodiment of the present invention. As shown in FIG. 4, since the elastic clip buckle 3 is provided in the rear section of the wind rope 2, such that when the tent 5 is pulled down, the wind rope 2 can be furled up for storage, to be wound up onto the adjusting plate 1. Then, the tail end of the wind rope 2 is put into the hook 12, while the elastic clip buckle 3 is placed on a side of the hook 12, to be bound tightly thereon, to achieve excellent fixing. As such, the wind rope 2 storage is easy, simple, and secure.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

1. A tent wind rope adjusting structure, comprising:
an adjusting plate, having a plate body, with a front section and a rear section of the plate body provided each with a through hole, a side of the adjusting plate is provided with at least a hook, the hook is formed by cutting a notch at a side of the plate body, and having a hook opening and an indent portion;
a wind rope, passing through the two through holes of the adjusting plate, with a tail end of the wind rope provided with a preformed rope loop, wherein the preformed rope loop is of fixed dimension and is non-removable, and the preformed rope loop is configured to be directly hooked on the hook; and
an elastic clip buckle, having a press-able rope clipping hole for the wind rope to pass through, such that the elastic clip buckle is placed between a rear section of the wind rope and the adjusting plate.

2. The tent wind rope adjusting structure as claimed in claim 1, wherein the adjusting plate is a flat plate body.

3. The tent wind rope adjusting structure as claimed in claim 1, wherein the adjusting plate is a crooked plate body.

4. The tent wind rope adjusting structure as claimed in claim 1, wherein the indent portion of the adjusting plate is of an arc shape.

5. The tent wind rope adjusting structure as claimed in claim 1, wherein the adjusting plate is of a shape selected from one of a group consisting of: a long rectangle, an ellipse, an arc-dart, a quadrilateral, a triangle, a polygon, and a bone.

6. The tent wind rope adjusting structure as claimed in claim 1, wherein the elastic clip buckle is formed by an upper hole cover piece, a lower hole cover piece, and a spring disposed therein.
